(19) United States
(12) Patent Application Publication
(10) Pub. No.: US 2026/0241383 A1
(43) Pub. Date: Aug. 20, 2026

(54) SAMPLE PRESERVATION CONTAINER

(71) Applicant: BIONLIFESCIENCE, INC., Namyangju-si, Gyeonggi-do (KR)

(72) Inventor: Chang Wook GOH, Namyangju-si, Gyeonggi-do (KR)

(21) Appl. No.: 18/843,317

(22) PCT Filed: Feb. 24, 2023
(86) PCT No.: PCT/KR2023/002632

§ 371 Date: Sep. 3, 2024

(30) Foreign Application Priority Data
Mar. 3, 2022 (KR) 10-2022-0027209

(51) Int. Cl. B01L 3/00

(52) U.S. Cl. CPC B01L 3/50825; B01L 2200/025; B01L 2200/0689; B01L 2300/042

(57) ABSTRACT

The present invention relates to a sample preservation container. According to the present invention, the sample preservation container comprises: a container body having an accommodation space and provided with a coupling nut section; and a lid for sealing the accommodation space. The lid includes: a coupling bolt section that is in surface contact with and coupled to the coupling nut section; and a lid section for sealing the accommodation space, and thus can seal the accommodation space even without components such as O-rings and can improve the production efficiency of the sample preservation container due to the manufacturing process being simpler.

### TECHNICAL FIELD

The present invention relates to a sample preservation container, and more particularly, to a sample preservation container capable of sealing an accommodation space configured to accommodate a sample therein without a sealing part such as an O-ring.

### BACKGROUND ART

With development of medical techniques, various medical examinations have been widely conducted so as to find a cause of a disease and treat the disease according to results of the medical examinations. In the medical examinations, after a sample is collected from blood, saliva, or tissues of body organs of a test subject, various tests such as a biochemical test, an immune serum test, and a hematology test are conducted on the collected sample so as to examine health status and disease status of the test subject.

Therefore, in order to secure accuracy of the medical examinations, it is required to prevent the sample collected from the test subject from being contaminated from the outside, and it is also important to prevent any damage to or loss of the collected sample.

To this end, the collected sample is accommodated and preserved in a sample preservation container containing a sample preservation solution therein, such as formalin, and is transported in a state of being accommodated and preserved in the sample preservation container. Here, it is necessary to prevent leakage of the sample accommodated in the sample preservation container and the sample preservation solution contained therein. Furthermore, it is also required to prevent the collected sample from being contaminated by foreign substances introduced from the outside.

In consideration of the above-described circumstances, the sample preservation container has been required to provide a sealing part such as an O-ring to prevent leakage of the sample and the sample preservation solution, in which the sealing part is interposed between a lid part of the sample preservation container and a tube-shaped container main body part thereof and is configured to seal the inside of the container main body part.

Meanwhile, since the O-ring needs to be inserted into each sample preservation container in the process of manufacturing the sample preservation container, the manufacturing process is complicated, resulting in deterioration in manufacturing efficiency.

### DISCLOSURE

### Technical Problem

Therefore, the present invention has been made in view of the above problems, and it is an object of the present invention to provide a sample preservation container capable of sealing a space provided therein and configured to accommodate and preserve a sample without a sealing part such as an O-ring.

### Technical Solution

In accordance with the present invention, the above and other objects can be accomplished by the provision of a sample preservation container including a container main body part formed to have a shape of a container or a tube with a predetermined length, an outer diameter, and an inner diameter, wherein the container main body part is formed to have one open side and has an accommodation space provided on an inner side thereof and configured to accommodate a predetermined sample or fluid, and a lid part having a portion on a front side thereof, wherein the portion is partially inserted into and coupled to one side of the container main body part so as to seal the accommodation space from an outer side of the container main body part, wherein the container main body part has a coupling nut section provided on the one side thereof, wherein the coupling nut section has a concave portion and a convex portion provided on an inner surface thereof, wherein each of the concave portion and the convex portion is formed to have a spiral shape so as to rotate around a longitudinal central axis of the container main body part, and the lid part includes a coupling bolt section having an outer circumferential surface formed to have a shape corresponding to a shape of the inner surface of the coupling nut section, wherein the outer circumferential surface of the coupling bolt section contacts the inner surface of the coupling nut section so as to perform coupling between the container main body part and the lid part, and a lead section located at a front side of the coupling bolt section and formed to have an outer circumferential surface, wherein at least a part of the outer circumferential surface contacts the inner surface of the container main body part so as to seal the accommodation space.

The lid part may further include a cap section located at a rear side of the coupling bolt section so as to enable a user to handle the lid part, wherein the cap section may have an outer diameter formed to be smaller than or equal to the outer diameter of the container main body part.

The lid part may further include a sealing support section located between the coupling bolt section and the cap section so as to support the coupling bolt section and formed to have an outer circumferential surface, wherein at least a part of the outer circumferential surface of the sealing support section may contact the inner surface on the one side of the container main body part so as to seal the inner side of the container main body part.

The container main body part may be made of a transparent material so as to enable a state of the accommodation space to be checked from the outer side thereof.

At least the part of the outer circumferential surface of the lead section of the lid part may be formed in a tapered shape having a smaller outer diameter in a direction approaching the front side of the lid part.

The container main body part may have an inner circumferential surface, wherein at least a part of the inner circumferential surface may be formed to be inclined so as to contact the outer circumferential surface formed to be tapered at the lead section.

### Advantageous Effects

The present invention provides a sample preservation container configured to seal a space provided therein and configured to accommodate and preserve a sample through coupling between a container main body part of the sample preservation container and a lid part thereof without a sealing part such as an O-ring, thereby safely preserving or transporting the sample. Further, the sample preservation container does not require the above-mentioned sealing part in a manufacturing process thereof, thereby having an effect of improving efficiency in the manufacturing process.

### DESCRIPTION OF DRAWINGS

FIG. 1 is an exploded perspective view schematically showing a sample preservation container according to an embodiment of the present invention;

FIG. 2 is a cross-sectional view schematically showing a container main body part of the sample preservation container according to the embodiment of the present invention;

FIG. 3 is a cross-sectional view schematically showing a lid part of the sample preservation container according to the embodiment of the present invention; and

FIG. 4 is a cross-sectional view schematically showing the sample preservation container according to the embodiment of the present invention.

### BEST MODE

The present invention may be modified in various ways and may have various embodiments, and specific embodiments will be described in detail with reference to the accompanying drawings. However, it should be understood that the present invention is not limited to the specific embodiments, and the specific embodiments include all modifications, equivalents, and substitutes that fall within the spirit and technical scope of the present invention. The embodiments are provided to more completely explain the present invention to those having ordinary knowledge in the art. Therefore, the shapes of elements in the drawings may be exaggerated to emphasize a clearer description. A detailed description of related known configurations or functions incorporated herein will be omitted when it is determined that the detailed description thereof may unnecessarily obscure the gist of the present invention.

Meanwhile, in the present invention, terms such as “first” and/or “second” may be used to describe various components, but the components are not limited by the terms. The terms are used only for the purpose of distinguishing one component from other components.

Terms used in the present invention are only used to describe specific embodiments and are not intended to limit the present invention. In this specification, an expression in a singular form also includes the plural sense, unless clearly specified otherwise in context.

It should be understood that expressions such as “comprise” and “have” in this specification are intended to designate the presence of indicated features, numbers, steps, operations, components, parts, or combinations thereof, but do not exclude the presence or addition of one or more features, numbers, steps, operations, components, parts, or combinations thereof.

Hereinafter, the present invention will be described in detail with reference to the accompanying drawings so that those skilled in the art to which the present invention pertains may easily implement the present invention. However, the present invention may be implemented in various ways and is not limited to the embodiments described herein. Wherever possible, the same reference numbers will be used throughout the drawings to refer to the same or like parts.

Hereinafter, a sample preservation container according to an embodiment of the present invention will be described with reference to the drawings.

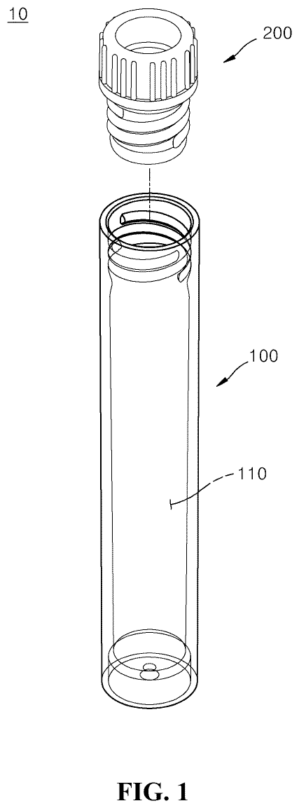

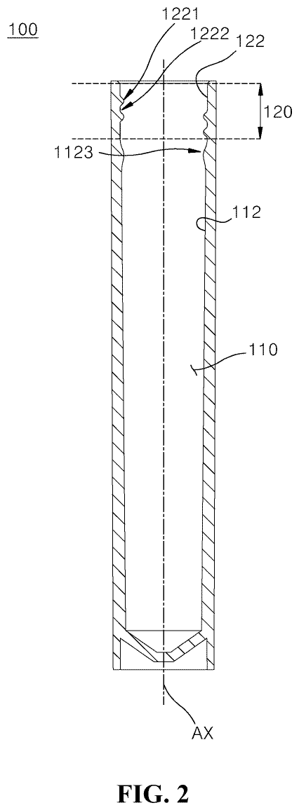

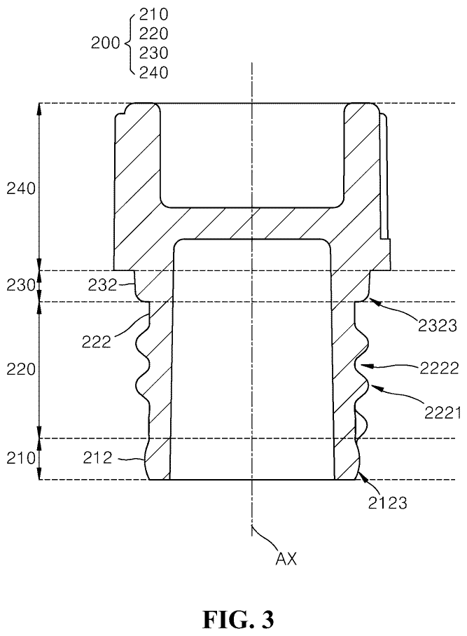

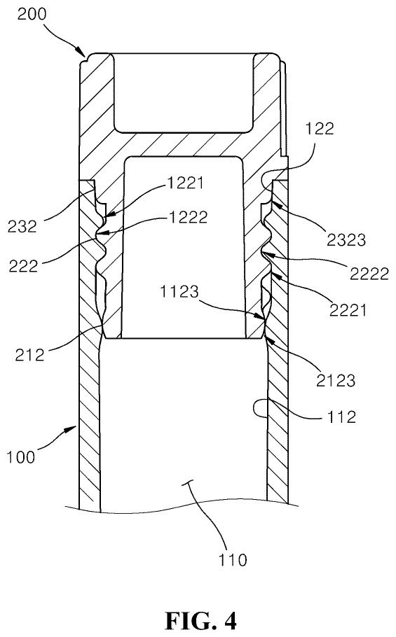

FIG. 1 is an exploded perspective view schematically showing a sample preservation container according to an embodiment of the present invention, FIG. 2 is a cross-sectional view schematically showing a container main body part of the sample preservation container according to the embodiment of the present invention, FIG. 3 is a cross-sectional view schematically showing a lid part of the sample preservation container according to the embodiment of the present invention, and FIG. 4 is a cross-sectional view schematically showing the sample preservation container according to the embodiment of the present invention.

Referring to FIGS. 1 to 4, a sample preservation container 10 according to the embodiment of the present invention includes a container main body part 100 and a lid part 200.

As shown in the drawings, the container main body part 100 has a shape of a container or a tube with a predetermined length, an outer diameter, and an inner diameter. Here, the container main body part 100 is formed to have one open side and has an accommodation space 110 provided on the inner side thereof and configured to accommodate a predetermined sample or fluid.

Here, the accommodation space 110 provided in the container main body part 100 may be sealed by coupling the lid part 200 to the container main body part 100. In this manner, the accommodation space 110 may be protected from the outside.

The container main body part 100 is preferably made of a transparent material so as to enable a user to check the state of the accommodation space 110 from the outside. When the container main body part 100 is made of a transparent material, the amount and state of the sample or fluid accommodated in the accommodation space 110 is preferably checked.

Additionally, the container main body part 100 has a coupling nut section 120 provided on one side thereof. Here, the coupling nut section 120 has a concave portion 1222 and a convex portion 1221 formed on the inner surface 122 of the coupling nut section 120, in which each of the concave portion 1222 and the convex portion 1221 is formed to have a spiral shape so as to rotate around a longitudinal central axis AX of the container main body part 100. That is, as shown in FIG. 2, the coupling nut section 120 is provided on one open side of the container main body part 100.

A direction in which the concave portion 1222 and the convex portion 1221 formed on the inner surface 122 of the container main body part 100 rotates around the longitudinal central axis AX of the container main body part 100 is not limited to a specific direction. That is, a clockwise spiral shape or a counterclockwise spiral shape may be formed.

In addition, an outer circumferential surface 222 of a coupling bolt section 220 at a lid part 200 to be described later is formed to have a shape corresponding to a shape of the inner surface 122 of the coupling nut section 120. That is, the outer circumferential surface 222 and the inner surface 122 come into contact with each other so as to be interlocked with each other. Therefore, when the lid part 200 is inserted into one open side of the container main body part 100, the coupling bolt section 220 of the lid part 200 and the coupling nut section 120 may be coupled to each other in a bolt-and-nut coupling manner.

In order to enable the coupling bolt section 220 of the lid part 200 and the coupling nut section 120 of the container main body part 100 to be coupled to each other in a bolt-and-nut coupling manner, an outer diameter of the coupling bolt section 220 of the lid part 200 is determined to be aligned with an inner diameter of the coupling nut section 120 of the container main body part 100.

In addition, a partial inner circumferential surface 1123 is formed on the inner circumferential surface 112 of the container main body part 100. Here, the partial inner circumferential surface 1123 is preferably formed to be inclined so as to contact an outer circumferential surface 2123 formed to have a tapered shape at a lead section 210 of the lid part 200 to be described later. Here, an inclined direction of the partial inner circumferential surface 1123, that is, a tangential direction of the inner circumferential surface 1123 is preferably formed to have a shape oriented toward the inner central axis AX, as shown in the drawing.

When the lid part 200 is coupled to the container main body part 110, the partial inner circumferential surface 1123 of the container main body part 100 contacts the outer circumferential surface 2123 of the lid part 200 so as to be in close contact with each other. Therefore, the accommodation space 110 is sealed from the outside.

In this manner, the outer circumferential surface 2123 formed to have a tapered shape at the lead section 210 of the lid part 200 is in contact with the inclined partial inner circumferential surface 1123 of the inner circumferential surface 112 of the container main body part 100, thereby making it possible to seal the accommodation space 110.

A surface of an edge portion of one end on the one open side of the container main body part 100 is formed to be inclined toward the inner side of the container main body part 100.

When the edge portion of the one end of the container main body part 100 is formed to be inclined toward the inner side of the container main body part 100, the lid part 200 may be guided to be inserted into the one end on the one open side of the container main body part 100. Further, the edge portion of the one end of the container main body part 100 may be in contact with a sealing support section or a cap section 240 of the lid part, thereby sealing the inner side of the container main body part 100.

A part of the front side of the lid part 200 is inserted into and coupled to one side of the container main body part 100, thereby sealing the accommodation space 110 from the outside.

The lid part 200 includes the coupling bolt section 220 and the lead section 210, and may further include the cap section 240 and the sealing support section 230.

The outer circumferential surface 222 of the coupling bolt section 220 is formed to have a shape corresponding to a shape of the inner surface 122 of the coupling nut section 120. In this manner, the surface of the coupling bolt section 220 is in contact with the inner surface 122 of the coupling nut section 120 such that a part of the front side of the lid part 200 is inserted into and coupled to one side of the container main body part 100 in a bolt-and-nut coupling manner.

That is, a concave portion 2222 and a convex portion 2221 provided on the outer circumferential surface 222 of the coupling bolt section 220 of the lid part 200 are each formed in a spiral shape and are each configured to rotate around the longitudinal central axis AX of the lid part 200 or the container main body part 100.

Therefore, the surface of the coupling bolt section 220 and the surface of the coupling nut section 120 may be coupled to and interlocked with each other, as shown in FIG. 4, and the inner side of the container main body part 100 is also sealed by coupling between the coupling bolt section 220 and the coupling nut section 120.

The lead section 210 is located on the front side of the coupling bolt section 220, and at least a part of the outer circumferential surface 212 of the lead section 210 contacts the inner circumferential surface 112 of the container main body part 100 so as to seal the accommodation space 110.

The outer diameter of the lead section 210 of the lid part 200 is formed to be smaller than or equal to the maximum outer diameter of the coupling bolt section 220. At least a part of the outer circumferential surface 2123 is preferably formed in a tapered shape such that the outer diameter of the outer circumferential surface 2123 becomes smaller in a direction approaching the front side.

As described above, the partial inner circumferential surface 1123 of the inner circumferential surface 112 of the container main body part 100 is formed to be inclined so as to contact the outer circumferential surface 2123 formed to be tapered at the lead section 210 of the lid part 200.

As described above, a part of the outer circumferential surface 2123 of the lead section 210 is formed to be tapered such that the outer diameter of the outer circumferential surface 2123 becomes smaller in a direction approaching the front side. Accordingly, a part of the outer circumferential surface 2123 may be in contact with the partial inner circumferential surface 1123 of the inner circumferential surface 112 of the container main body part 100, thereby sealing the accommodation space.

In this manner, the partial inner circumferential surface 1123 of the container main body part 100 is preferably formed to be inclined so as to contact the outer circumferential surface 2123 formed to be tapered at the lead section 210.

The cap section 240 is located at the rear side of the coupling bolt section 220 so as to allow a user to handle the lid part 200. Further, the outer diameter of the cap section 240 is preferably formed to be smaller than or equal to the outer diameter of the container main body part 100.

A liquid handler (not shown) widely distributed to handle multiple sample preservation containers is provided with a plurality of mounting grooves or mounting holes each corresponding to the outer diameter of a corresponding one of the container main body parts 100 to be mounted. However, in most of the conventional sample preservation containers, the diameter of the lid part is manufactured to be larger than the outer diameter of the container main body part.

Therefore, when the multiple sample preservation containers are mounted on the liquid handler, interference between the lid parts of the adjacent sample preservation containers is caused by collision and pressure between the lid parts adjacent to each other.

Accordingly, when the outer diameter of the cap section 240 is formed to be smaller than or equal to the outer diameter of the container main body part 100, the multiple sample preservation containers mounted on the liquid handler do not interfere with each other. Therefore, there is an advantage in that it is easy to treat the liquid handler and the sample preservation containers.

The sealing support section 230 is located between the coupling bolt section 220 and the cap section 240 so as to support the coupling bolt section 220. Further, the sealing support section 230 seals the inner side of the container main body part 100 by allowing at least a part of outer circumferential surfaces 232 and 2323 of the sealing support section 230 to contact the inner surface 122 of one side of the container main body part 100.

Although not clearly shown in the drawing, the outer circumferential surface 232 of the sealing support section 230 is also preferably formed to be tapered such that the outer diameter of the outer circumferential surface 232 decreases in a direction approaching the front side of the lid part 200.

In addition, as shown in the drawing, the outer circumferential surface 232 of the sealing support section 230 preferably has a rounded front end edge portion 2323. Although not shown in the drawing, the edge portion 2323 rounded on the outer circumferential surface 232 of the sealing support section 230 may also be formed to contact the inner circumferential surface of the container main body part 100 so as to seal the inner side of the container main body part 100.

When the lid part 200 is inserted into and coupled to the container main body part 100, the outer circumferential surfaces 232 and 2323 of the sealing support section 230 contact the inner surface 122 of one side of the container main body part 100 so as to seal the inner side of the container main body part.

In this manner, the sample preservation container 10 according to the embodiment of the present invention does not require a separate sealing part such as an O-ring, and when the lid part 200 is coupled to the container main body part 100, the lead section 210 seals the accommodation space 110. Further, the coupling bolt section 220 and the coupling nut section 120 are coupled to each other in a bolt-and-nut coupling manner so as to seal the inner side of the container main body part, and the sealing support section 230 and the inner surface 122 of the container main body part 100 contact each other so as to seal the inner side of the container main body part.

Therefore, since sealing or airtightness is achieved at three portions allowing the lid part 200 and the container main body part 100 to come into contact with each other, it is possible to isolate and preserve a sample or fluid accommodated in the accommodation space.

Additionally, if necessary, the lid part 200 may have a sample collection stick mounting means provided on the inner side thereof and configured to allow a sample collection stick to be mounted parallel to the central axis AX of the lid part 200. In this case, the sample collection stick may be safely accommodated in the accommodation space 110 by the sample preservation container 10.

In this manner, the sample preservation container according to the present invention may seal an accommodation space configured to accommodate a sample therein through coupling between a container main body part of the sample preservation container and a lid part thereof without a sealing part such as an O-ring, thereby making it possible to reliably preserve and transport the sample. Furthermore, the sample preservation container does not require the above-mentioned sealing part in a manufacturing process thereof and, as such, the manufacturing process becomes simple. Accordingly, there is an advantage in that manufacturing efficiency of the sample preservation container is improved. Therefore, there is an advantage in that manufacturing efficiency of the sample preservation container can be improved.

As described above, the present invention has been described through embodiments with reference to the accompanying drawings. However, since the above-described embodiments are only described as preferred embodiments of the present invention, the present invention should not be construed as being limited to the embodiments. The scope of the present invention should be defined in the appended claims and equivalents thereto.

1. A sample preservation container comprising:
a container main body part formed to have a shape of a container or a tube with a predetermined length, an outer diameter, and an inner diameter, wherein the container main body part is formed to have one open side and has an accommodation space provided on an inner side thereof and configured to accommodate a predetermined sample or fluid; and
a lid part having a portion on a front side thereof, wherein the portion is partially inserted into and coupled to one side of the container main body part so as to seal the accommodation space from an outer side of the container main body part, wherein:
the container main body part has a coupling nut section provided on the one side thereof, wherein the coupling nut section has a concave portion and a convex portion provided on an inner surface thereof, wherein each of the concave portion and the convex portion is formed to have a spiral shape so as to rotate around a longitudinal central axis of the container main body part, and
the lid part comprises:
a coupling bolt section having an outer circumferential surface formed to have a shape corresponding to a shape of the inner surface of the coupling nut section, wherein the outer circumferential surface of the coupling bolt section contacts the inner surface of the coupling nut section so as to perform coupling between the container main body part and the lid part; and
a lead section located at a front side of the coupling bolt section and formed to have an outer circumferential surface, wherein at least a part of the outer circumferential surface contacts the inner surface of the container main body part so as to seal the accommodation space.

2. The sample preservation container according to claim 1, wherein the lid part further comprises a cap section located at a rear side of the coupling bolt section so as to enable a user to handle the lid part, wherein the cap section has an outer diameter formed to be smaller than or equal to the outer diameter of the container main body part.

3. The sample preservation container according to claim 2, wherein the lid part further comprises a sealing support section located between the coupling bolt section and the cap section so as to support the coupling bolt section and formed to have an outer circumferential surface, wherein at least a part of the outer circumferential surface of the sealing support section contacts the inner surface on the one side of the container main body part so as to seal the inner side of the container main body part.

4. The sample preservation container according to claim 1, wherein the container main body part is made of a transparent material so as to enable a state of the accommodation space to be checked from the outer side thereof.

5. The sample preservation container according to claim 1, wherein at least the part of the outer circumferential surface of the lead section of the lid part is formed in a tapered shape having a smaller outer diameter in a direction approaching the front side of the lid part.

6. The sample preservation container according to claim 5, wherein the container main body part has an inner circumferential surface, wherein at least a part of the inner circumferential surface is formed to be inclined so as to contact the outer circumferential surface formed to be tapered at the lead section.
